(19) United States
(12) Patent Application Publication
(10) Pub. No.: US 2006/0111217 A1
(43) Pub. Date: May 25, 2006

(54) Moveable gear type automatic stepless speed change device

(76) Inventor: Shih-Tzou Wen, Sanchong City (TW)

Correspondence Address: Shih-Tzou WEN;P.O. Box No. 6-57, Junghe, Taipei, 235, TW

(21) Appl. No.: 10/994,652

(22) Filed: Nov. 23, 2004

(51) Int. Cl. F16H 37/02

(52) U.S. Cl. 475/207

(57) ABSTRACT

A moveable gear type automatic stepless speed change device primarily structured to comprises an electric motor, a stepless speed change device and an automatic gear shift device. An output shaft of the electric motor is fixedly configured to one end of a main transmission shaft of the stepless speed change device, and the automatic gear shift device is disposedly configured on another end of the main transmission shaft. A rotating eccentric force of an eccentric drive plate of the stepless speed change device is actuated by means of the automatic gear shift device via an ascending and descending mechanism, thereby achieving effectiveness of automatically controlling stepless speed change.

### BACKGROUND OF THE INVENTION

(a) Field of the Invention

The present invent relates to a moveable gear type automatic stepless speed change device, and more particularly to a stepless speed change device that utilizes a planetary gear or moveable gear transmission to function in coordination with control from an automatic gear shift device, and which realizes a device having stepless type automatic speed change efficacy.

(b) Description of the Prior Art

A conventional speed change device for an automobile, a motorcycle or other transmission mechanisms can be generally categorized as pertaining to that of a stepped gear speed change device, or a stepless friction speed change device. However, structure of each of the two aforementioned conventional speed change devices possesses advantages and shortcomings, wherein one advantage of the stepped gear speed change device is a superior transmission efficiency, and one shortcoming is a necessity for the stepped gear speed change device to typically function in coordination with structure and operation of a clutch and a gear-shift lever, which results in a more complicated structure and difficult operation thereof. The stepless friction speed change device does not generally possess problem of controlling speed change, nonetheless, transmission efficiency of the structure of the stepless friction speed change device is relatively lower. Hence, the two aforementioned conventional speed change structures both possess shortcomings, and thus do not conform to practicability.

In accordance with the aforesaid shortcomings, the inventor of the present invention particularly designed improved structures for the speed change device, for instance, Taiwan new patent No. 130720, entitled Moveable Gear Type Stepless Speed Change Device, Taiwan new patent No. 168304, entitled Planetary Gear Stepless Gear Change Mechanism, Taiwan invention patent No. 64814t, entitled Slide Block Clutch Eccentric Stepless Speed Change Device, Taiwan invention patent No. 68349, entitled Stepless Gear Change Mechanism with Large Transmission Ratio, and U.S. Pat. Nos. 4,892,506, 5,127,883, and 5,222,916.

According to the aforementioned prior art, and referring to FIG. 5, which shows an embodiment of the moveable gear stepless speed change device of prior art, wherein a fixed turntable 11 and a moveable turntable 12 are installed interior of a housing 10 of the speed change device, and an eccentric drive plate 13 is configured between the fixed turntable 11 and the moveable turntable 12. Moreover, a plurality of radial slots 131 are provided on top of the eccentric drive plate 13. A short axis 132 penetrates interior of each of the slots 131, and the short axes are arranged in a staggered fashion. A rolling moveable gear 133 having a unidirectional drive function is separately pivotal configured on a left side end and a right side end of each of the short axes 132 (with such a configuration, a plurality of supporting radialized extended arms can be configured on the eccentric drive plate 13 within the planetary stepless speed change device. A rockable connecting rod is pivotal configured on an end portion of each of the extended arms, and a unidirectional rotating planetary gear is pivotal configured on an end portion of each of the connecting rods), and disposed in a symmetrical fashion within circular grooves 111 and 112 of the fixed turntable 11 and the moveable turntable 12 respectively, and meshing is actuated therewith. Furthermore, the eccentric drive plate 13 utilizes an ascending and descending mechanism 20 that rotates in synchronization with a main transmission shaft 14 and thereby controls a rotating eccentric force of the eccentric drive plate 13. Upon an electric motor 1 being fitted to one side of the housing 10, and rotation of the main transmission shaft 14 is actuated, an output force of the electric motor 1 is transmitted through the moveable turntable 12 and a secondary transmission shaft 15 and a sprocket that are connected to the moveable turntable 12 as a single body, and which provides for use thereof, thus achieving objectives of the stepless speed change device.

According to the aforesaid prior art, a shortcoming exists during operating speed change, wherein a manual method to operate acceleration or deceleration function of the speed change device is equally utilized. Hence, during practical usage, unideal areas become apparent, particularly with adoption of an automatic gear change structure by present automobiles and motorcycles, and as a consequence there is a definite need for further research in improvement of the aforementioned prior art.

In light of the shortcomings of conventional moveable gear type or planetary gear type stepless speed change device being unable to effectuate automatic speed change, the inventor of the present invention, having accumulated years of experience in design of related arts, attentively and circumspectly carried out extensive study and exploration to ultimately design a completely new structure for a moveable gear type automatic stepless speed change device.

A primary objective of the present invention is to provide the moveable gear type automatic stepless speed change device with a moveable gear type automatic stepless speed change mechanism that functions in coordination with an automatic speed change mechanism, wherein the automatic speed change mechanism utilizes a gear shift to actuate a differential gear, thereby enabling the differential gear to forward rotate relative to a control plate, and utilizes a counterforce of an electric motor (engine) to actuate reverse rotating of a brake relative to the control plate, and thus attain the automatic speed change mechanism that automatically controls position of an eccentric shaft of an ascending and descending mechanism interior of a main transmission shaft, and, moreover, enhances industrial utility value and economical benefit of the present invention.

### SUMMARY OF THE INVENTION

In order to achieve aforementioned objectives the present invention is primarily structured to comprises an electric motor, a stepless speed change device and an automatic gear shift device. Wherein the stepless speed change device is pivotal installed between two fixing mounts, and, moreover, a blocking piece is configured on one side of a gear that is connected to a secondary transmission shaft of the stepless speed change device, which is utilized to actuate rotating of a housing of the stepless speed change device. An output shaft of the electric motor is fixedly configured to one end of a main transmission shaft of the stepless speed change device. The automatic gear shift device is disposedly configured on another end of the main transmission shaft of the stepless speed change device. A rotating eccentric force of an eccentric drive plate of the stepless speed change device is actuated by means of the automatic gear shift device via an ascending and descending mechanism, thereby achieving effectiveness of automatically controlling stepless speed change. The present invention is characterized in that:

The ascending and descending mechanism is disposedly configured interior of the main transmission shaft and rotates in synchronization therewith. The ascending and descending mechanism comprises a control shaft, a first connecting rod and a second connecting rod. The control shaft can shift in a left and right direction interior of the main transmission shaft, and a section of screw thread is configured on an extremity of the control shaft. The second connecting rod is pivotal fixed to the main transmission shaft by means of a pin shaft; moreover, a front end of the second connecting rod forms a push top member. A mandril is configured on each of a top and bottom side of the push top member, and the mandrils penetrate the main transmission shaft so as to separately prop up against a bearing inner ring of the eccentric drive plate, with result that a left and right displacement force of the control shaft can be utilized to vary the push top member relative to an eccentric displacement force of a rotating axis.

The automatic gear shift device comprises fixing mounts that are utilized to pivotal install the stepless speed change device and an outer frame that is fixedly configured on the fixing mounts, and a differential gear set is configured interior of the outer frame on an extremity of the main transmission shaft and the control shaft extending from the stepless speed change device. Moreover, a gear control mechanism is configured on an extremity of the control shaft and on the outer frame.

The differential gear set is provided with an active gear fixedly configured on an extremity of the main transmission shaft, which rotates in synchronization therewith, and a passive gear threaded on an outer screw thread of an extremity of the control shaft. Outer edges of the active gear and the passive gear simultaneously mesh with a differential gear, and the differential gear is pivotal configured interior of a housing of the differential gear set. The housing forms a loose fit with the main transmission shaft, thereby allowing the housing to rotate along with the main transmission shaft. A friction block is configured so as to correspond to an outer edge of the housing, and which can actuate controlled friction with the housing, so that upon the housing rotating along with the main transmission shaft, resistance drag is thereby effectuated, and slowing down results as a consequence.

The gear control mechanism comprises a clutch plate and a control plate, wherein the clutch plate is configuredly sheathed on a flange of the control plate so as to be able to shift leftward and rightward thereon, and the clutch plate and the passive gear of the differential gear set mutually clasp and synchronously rotate or mutually separate. The control plate is threaded on an outer screw thread of a rear end of the control shaft; moreover, another side of the control plate closely adheres to an inner side surface of the outer frame and is thus rotatable. Furthermore, a plurality of springs are configured between the clutch plate and the control plate, which provide the clutch plate with a leftward displacement thrust that effectuates embedding with the aforementioned passive gear, and which actuates rotation of the control plate. In addition, a brake is configured so as to correspond to an outer edge of the clutch plate, the brake is provided with an inclined plane, and upon the brake effectuating a clamping braking effect with the clutch plate, the inclined plane first allows the clutch plate and the passive gear of the differential gear set to assume a state of disengagement, and, moreover, the brake along with the aforementioned friction block configured on the outer edge of the housing of the differential gear set thereby actuate coordinated control by means of a mutually exclusive mechanism.

Furthermore, an operating rod is pivotal configured on the outer frame, and one end of the operating rod is provided with a pressure plate that corresponds to an extremity of the control shaft. Another end of the operating rod is provided with a swing arm that can affect control by means of a steel wire and a recovery spring. The steel wire simultaneously linkage controls the aforementioned mutually exclusive mechanism.

According to the aforementioned, upon an operator pulling the steel wire tight, which thus pulls the swing arm, anticlockwise rotation of the operating rod is thereby actuated, whereafter, the pressure plate of the extremity of the operating rod presses on an extremity of the control shaft, moreover, the swing arm simultaneously presses a mutually exclusive mechanism, which thereby enables the friction block to realize clamping of the housing of the differential gear set, and thereby achieves effectiveness of producing automatic acceleration. Whereas, because of increase in counteractive torque on a casing of the electric motor (engine), thus slackening of the steel wire results, which thereby enables the brake to clamp the clutch plate and effectuate braking, and achieves effectiveness of producing automatic deceleration, During period the steel wire maintains a slackened state, the brake continues to clamp and hold the clutch plate, thereby enabling the control shaft to push the pressure plate, and thus effectuate a reverse rotation of the swing arm, which thereby realizes automatic tightening on the steel wire, resulting in stopping rotation, and thus achieves preventing a phenomenon of mechanistic deadlock from occurring.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view of an embodiment according to the present invention.

FIG. 2 shows an assembled cross-sectional view of the embodiment according to the present invention.

FIG. 3 shows a rear top view of the embodiment according to the present invention.

FIG. 4A shows a top view of entire structural configuration according to the present invention.

FIG. 4B shows a schematic view of a reset condition of an automatic gear change according to the present invention.

FIG. 4C shows a schematic view of manual pull acceleration of the automatic gear change according to the present invention.

FIG. 4D shows a schematic view of automatic readjustment deceleration of the automatic gear change according to the present invention.

FIG. 5 shows an assembled cross-sectional view of a conventional moveable gear stepless speed change device.

### DETAILED DESCRIPTION OF THE PREFERRED EMBODIMENTS

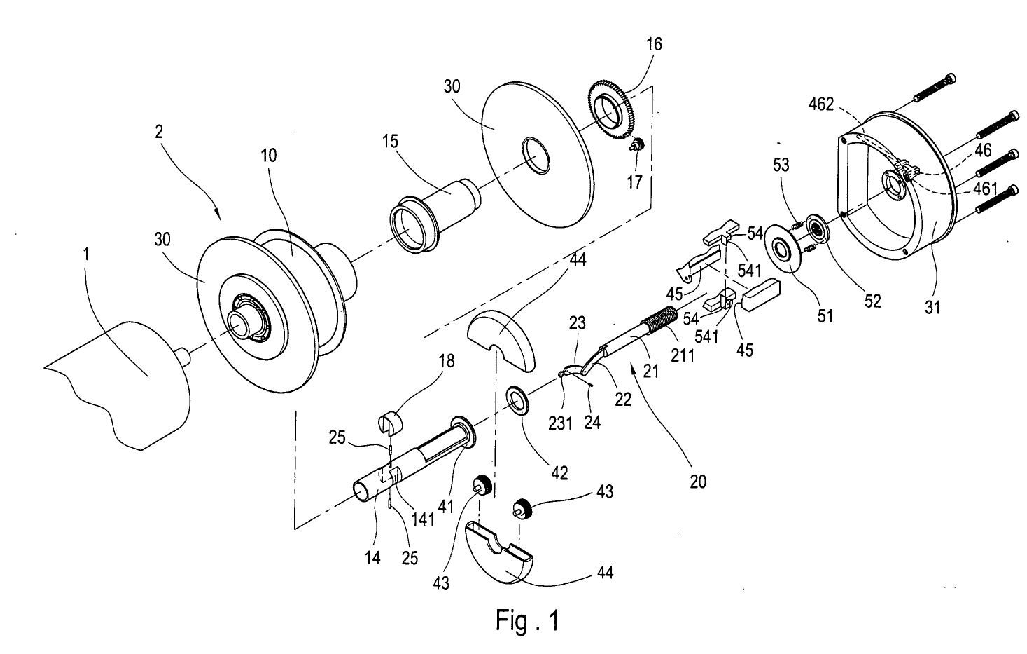

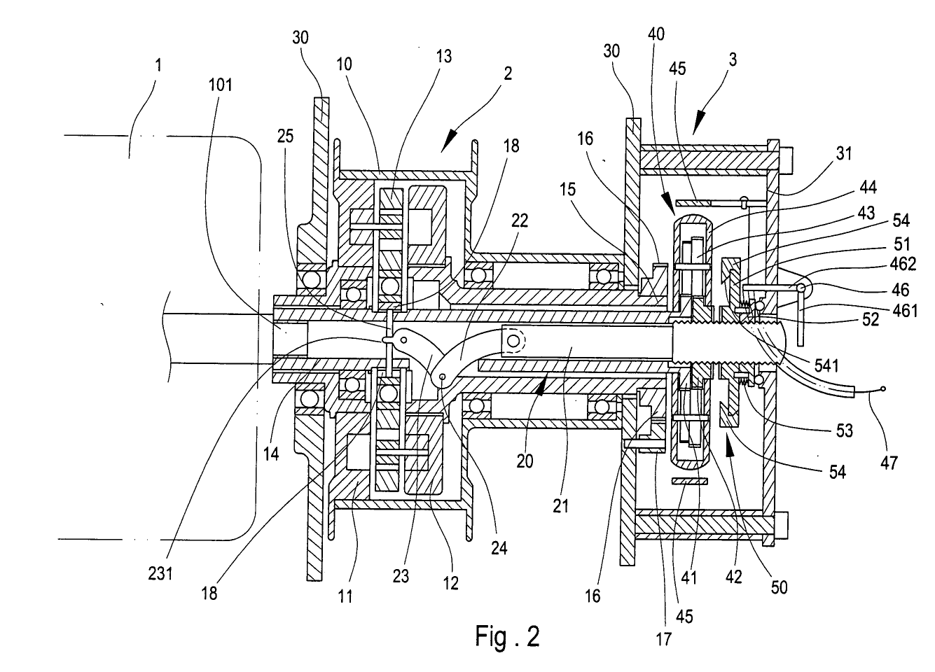

Referring to FIGS. 1 and 2 (wherein, if numbers of structural component members are same as those used to symbolize structural component members of the aforementioned conventional structure, such indicates that the structural component members have identical functionality), which shows a moveable gear type automatic stepless speed change device of the present invention structured to comprise an electric motor (engine) 1, a stepless speed change device 2 and an automatic gear shift device 3. Wherein the stepless speed change device 2 is pivotal installed between two fixing mounts 30, and, moreover, a blocking piece 17 is configured on one side of a gear 16 that is connected to a secondary transmission shaft 15 of the stepless speed change device 2, and wherewith actuates rotating of a housing 10 of the stepless speed change device 2. An output shaft 101 of the electric motor 1 is fixedly configured to one end of a main transmission shaft 14 of the stepless speed change device 2. The automatic gear shift device 3 is disposedly configured on another end of the main transmission shaft 14 of the stepless speed change device 2. A rotating eccentric force of an eccentric drive plate 13 of the stepless speed change device 2 is actuated by means of the automatic gear shift device 3 via an ascending and descending mechanism 20, thereby achieving effectiveness of automatically controlling stepless speed change. The present invention is characterized in that:

The ascending and descending mechanism 20 is disposedly configured interior of the main transmission shaft 14 and rotates in synchronization therewith. The ascending and descending mechanism 20 comprises a control shaft 21, a first connecting rod 22 and a second connecting rod 23, and which are so structured to be pivotal connected to form a crankshaft. The control shaft 21 can shift in a left and right direction interior of the main transmission shaft 14, moreover, a section of screw thread 211 is configured on an extremity of the control shaft 21, and the second connecting rod 23 is pivotal fixed to the main transmission shaft 14 by means of a pin shaft 24. Furthermore, a front end of the second connecting rod 23 forms a push top member 231. A mandril 25 is configured on each of a top and bottom side of the push top member 231, and the mandrils 25 penetrate the main transmission shaft 14 so as to separately prop up against a bearing inner ring of the eccentric drive plate 13, with result that a left and right displacement force of the control shaft 21 can be utilized to vary the push top member 231 relative to an eccentric displacement force of a rotating axis. According to the aforementioned, wherein a slide sheath 18 having an inverted U-shaped groove is configured on a bearing of the eccentric drive plate 13, a parallel tangent plane 141 is configured on the main transmission shaft 14 so as to correspond to the slide sheath 18 having the inverted U-shaped groove. Hence, upon the slide sheath 18 being subjected to pushing from the mandrils 25, perpendicular displacement on the main transmission shaft 14 is effectuated subject to restraint of the parallel tangent plane 141.

The automatic gear shift device 3 comprises fixing mounts 30 that are utilized to pivotal install the stepless speed change device 2 and an outer frame 31 that is fixedly configured on the fixing mounts 30. A differential gear set 40 is configured interior of the outer frame 31 on an extremity of the main transmission shaft 14 and the control shaft 21 extending from the stepless speed change device 2, and a gear control mechanism 50 is configured on an extremity of the control shaft 21 and on the outer frame 31.

The differential gear set 40 is provided with an active gear 41 fixedly configured on an extremity of the main transmission shaft 14, which rotates in synchronization therewith, and a passive gear 42 threaded onto an outer screw thread 211 of an extremity of the control shaft 21. Furthermore, outer edges of the active gear 41 and the passive gear 42 simultaneously mesh with a differential gear 43. The differential gear 43 is pivotal configured interior of a housing 44 of the differential gear set 40. The housing 44 forms a loose fit with the main transmission shaft 14, thereby allowing the housing 44 to rotate along with the main transmission shaft 14. A friction block 45 is configured so as to correspond to an outer edge of the housing 44, and which can actuate controlled friction with the housing 44, so that upon the housing 44 rotating along with the main transmission shaft 14, resistance drag is thereby effectuated, and slowing down results as a consequence.

The gear control mechanism 50 comprises a clutch plate 51 and a control plate 52. The clutch plate 51 is configuredly sheathed on a flange of the control plate 52, and can shift leftward and rightward thereon. The clutch plate 51 and the passive gear 42 of the differential gear set 40 mutually clasp and synchronously rotate or mutually separate. The control plate 52 is threaded on an outer screw thread 211 of a rear end of the control shaft 21; moreover, another side of the control plate 52 closely adheres, to an inner side surface of the outer frame 31 and is thus rotatable. Furthermore, a plurality of springs 53 are configured between the clutch plate 51 and the control plate 52, which provide the clutch plate 51 with a leftward displacement thrust that effectuates embedding with the aforementioned passive gear 42, and which actuates rotation of the control plate 52 configured right thereof. In addition, a brake 54 is configured so as to correspond to an outer edge of the clutch plate 51. The brake 54 is provided with an inclined plane 541, and upon the brake 43 effectuating a clamping braking effect with the clutch plate 51, the inclined plane 541 first allows the clutch plate 51 and the passive gear 42 of the differential gear set 40 to assume a state of disengagement, and, moreover, the brake 54 along with the aforementioned friction block 45 configured on the outer edge of the housing 44 of the differential gear set 40 thereby actuate coordinated control by means of a mutually exclusive mechanism 60.

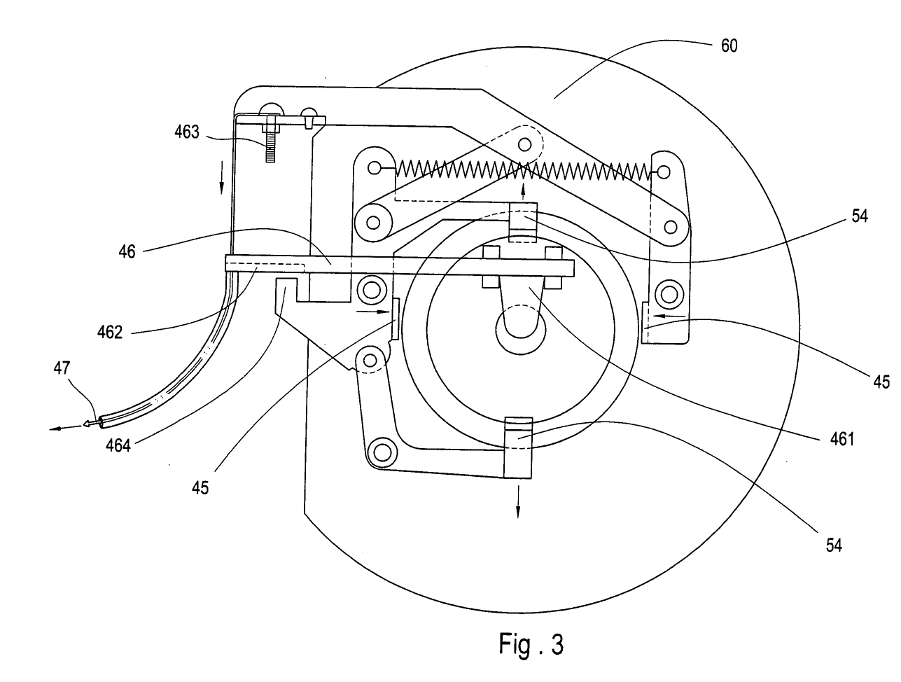

Furthermore, an operating rod 46 is pivotal configured on the outer frame 31 (see FIG. 3), and one end of the operating rod 46 is provided with a pressure plate 461 that corresponds to an extremity of the control shaft 21. Another end of the operating rod 46 is provided with a swing arm 462 that can affect control by means of a steel wire 47 and a recovery spring 48. The steel wire 47 simultaneously linkage controls the aforementioned mutually exclusive mechanism 60.

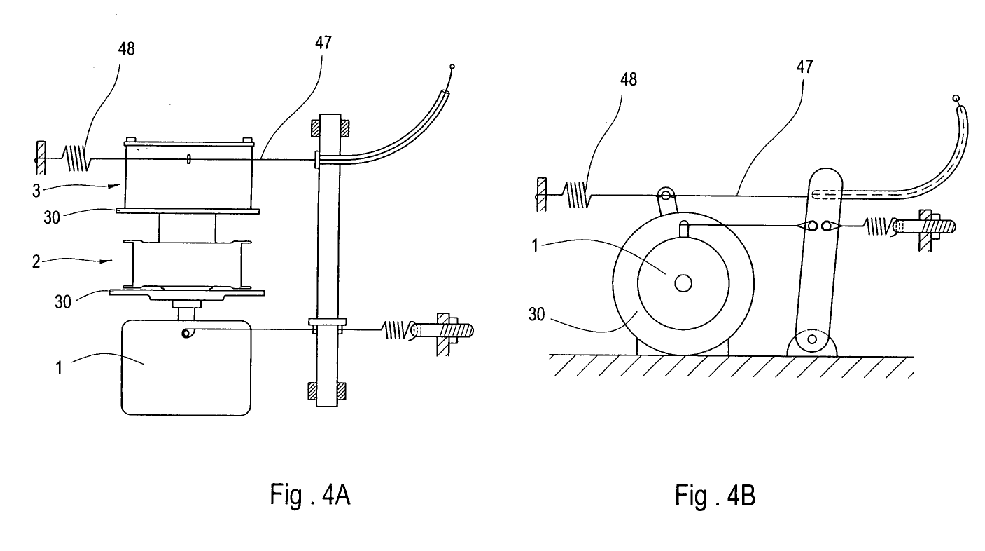

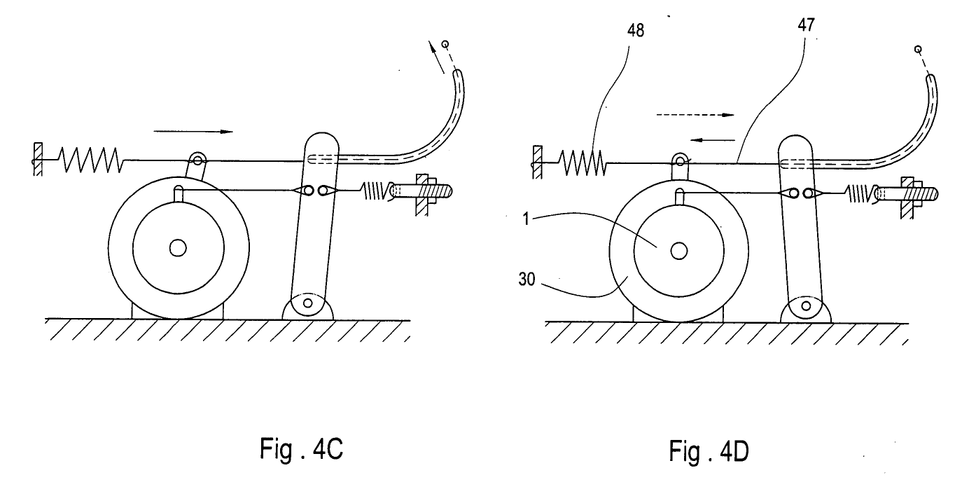

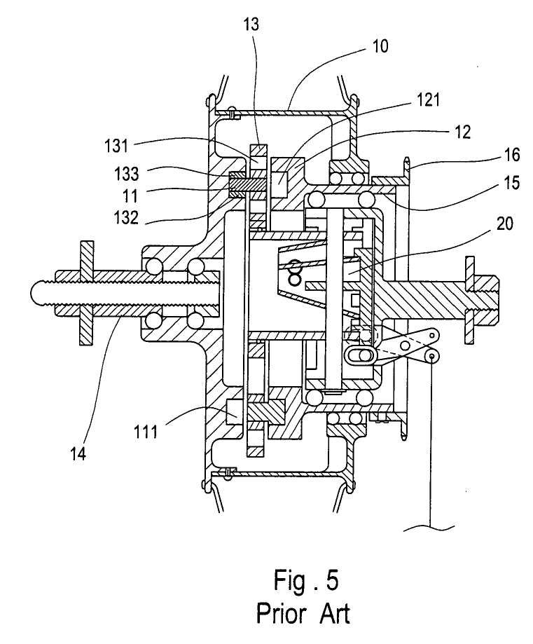

According to the aforementioned, and in conjunction with FIG. 3 and FIGS. 4A, 4B, 4C and 4D, upon an operator pulling the steel wire 47 tight, which thus pulls the swing arm 462, anticlockwise rotation of the operating rod 46 is thereby actuated, whereafter, the pressure plate 461 of the extremity of the operating rod 46 presses on an extremity of the control shaft 21, and pulling on the mutually exclusive mechanism 60 by the swing arm 462 thereby enables the friction block 45 to realize clamping of the housing 44 of the differential gear set 40, and which thus effectuates decelerating rotating speed thereof. Upon reducing rotating speed of the housing 44, the passive gear 42 is subjected to effect of the differential gear 43, thereby enabling rotating speed of the passive gear 42 to correspondingly rotate relatively faster than the control shaft 21, whereafter, the passive gear 42 is utilized to effectuate leftward displacement of the control shaft 21 through a screw thread meshing relationship of the control plate 52 and the control shaft 21, which thus actuates an enlargement in the eccentric force of the push top member 231 configured on the front end of the second connecting rod 23 of another end of the control shaft 21, and thereby achieves effectiveness of acceleration. Top acceleration is attained when a blocking screw 463 comes in contact with the swing arm 462. Whereas, when load is relatively large, a counteractive phenomenon of backspin of a casing of the electric motor 1 occurs, and because of increase in counteractive torque on the casing of the electric motor 1 (engine), thus slackening of the steel wire 47 results, which thereby actuates rotating of the operating rod 46 in an anticlockwise direction, and the aforementioned friction block 45 is thus pulled back from the housing 44, resulting in slackening thereof. Simultaneously, linkage of the mutually exclusive mechanism 60 enables the brake 54 to clamp the clutch plate 51 and effectuate braking. Prior to braking, the clutch plate 51 is pushed backward by the inclined plane 541 of the brake 54, which thus effectuates disengagement from the passive gear 42 of the differential gear set 42, whereupon a braking action is actualized, which actuates stopping rotating of the clutch plate 51 and the control plate 52, and, correspondingly, effectuates rightward displacement of the control shaft 21 along with rotating of the transmission shaft 14, thereby allowing a decrease in the eccentric force of the top push member 231 of the second connecting rod 23 configured on another end of the control shaft 21, which thereby generating effectiveness of automatic deceleration. When load recovery is relatively small, then counterforce of the casing of the electric motor 1 is reduced, and automatic tightening of the steel wire 47 is effectuated, which results in effectiveness of automatic acceleration. In addition, during period the steel wire 47 maintains a slackened state, the brake 54 continues to clamp and hold the clutch plate 51, thereby enabling the control shaft 21 to push the pressure plate 461, and thus effectuate a reverse rotation of the swing arm 462, which thereby realizes automatic tightening on the steel wire 47. Moreover, the swing arm 462 also rotates and cones in contact with another blocking member 464, resulting in stopping rotation and restricting structure thereof, thereby achieving objective of preventing overrunning of mechanism, and thus avoiding phenomenon of a deadlock from occurring.

In conclusion, the present invention in surmounting structural shortcomings of prior art, has assuredly achieved effectiveness of providing the speed change device with functionality of automatic stepless speed change, and that enhances industrial utility value thereof, and advancement and practicability of the present invention comply with essential elements as required for a new patent application. Accordingly, a new patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A moveable gear type automatic stepless speed change device comprising an electric motor, a stepless speed change device and an automatic gear shift device, wherein the stepless speed change device is pivotal installed between two fixing mounts, and, moreover, a blocking piece is configured on one side of a gear that is connected to a secondary transmission shaft of the stepless speed change device, which is utilized to actuate rotating of a housing of the stepless speed change device; an output shaft of the electric motor is fixedly configured to one end of a main transmission shaft of the stepless speed change device, the automatic gear shift device is disposedly configured on another end of the main transmission shaft of the stepless speed change device, and a rotating eccentric force of an eccentric drive plate of the stepless speed change device is actuated by means of the automatic gear shift device via an ascending and descending mechanism, thereby achieving effectiveness of automatically controlling stepless speed change; and characterized in that:
the ascending and descending mechanism is disposedly configured interior of the main transmission shaft and rotates in synchronization therewith, the ascending and descending mechanism comprises a control shaft, a first connecting rod and a second connecting rod, the control shaft can shift in a left and right direction interior of the main transmission shaft, and a section of screw thread is configured on an extremity of the control shaft, and the second connecting rod is pivotal fixed to the main transmission shaft by means of a pin shaft, moreover, a front end of the second connecting rod forms a push top member, a mandril is configured on each of a top and bottom side of the push top member, and the mandrils penetrate the main transmission shaft so as to separately prop up against a bearing inner ring of the eccentric drive plate, with result that a left and right displacement force of the control shaft can be utilized to vary the push top member relative to an eccentric displacement force of a rotating axis;
the automatic gear shift device comprises fixing mounts that are utilized to pivotal install the stepless speed change device and an outer frame that is fixedly configured on the fixing mounts, and a differential gear set is configured interior of the outer frame on an extremity of the main transmission shaft and the control shaft extending from the stepless speed change device, and, moreover, a gear control mechanism is configured on an extremity of the control shaft and on the outer frame; the differential gear set is provided with an active gear fixedly configured on an extremity of the main transmission shaft, which rotates in synchronization therewith, and a passive gear threaded on an outer screw thread of an extremity of the control shaft, outer edges of the active gear and the passive gear simultaneously mesh with a differential gear, and the differential gear is pivotal configured interior of a housing of the differential gear set, the housing forms a loose fit with the main transmission shaft, thereby allowing the housing to rotate along with the main transmission shaft, a friction block is configured so as to correspond to an outer edge of the housing, and which can actuate controlled friction with the housing, so that upon the housing rotating along with the main transmission shaft, resistance drag is thereby effectuated, and slowing down results as a consequence;
the gear control mechanism comprises a clutch plate and a control plate, wherein the clutch plate is configuredly sheathed on a flange of the control plate so as to be able to shift leftward and rightward thereon, and the clutch plate and the passive gear of the differential gear set mutually clasp and synchronously rotate or mutually separate, the control plate is threaded on an outer screw thread of a rear end of the control shaft, moreover, another side of the control plate closely adheres to an inner side surface of the outer frame and is thus rotatable; furthermore, a plurality of springs are configured between the clutch plate and the control plate, which provide the clutch plate with a leftward displacement thrust that effectuates embedding with the aforementioned passive gear, and which actuates rotation of the control plate; in addition, a brake is configured so as to correspond to an outer edge of the clutch plate, the brake is provided with an inclined plane, and upon the brake effectuating a clamping braking effect with the clutch plate, the inclined plane first allows the clutch plate and the passive gear of the differential gear set to assume a state of disengagement, and, moreover, the brake along with the aforementioned friction block configured on the outer edge of the housing of the differential gear set thereby actuate coordinated control by means of a mutually exclusive mechanism;
furthermore, an operating rod is pivotal configured on the outer frame, and one end of the operating rod is provided with a pressure plate that corresponds to an extremity of the control shaft, another end of the operating rod is provided with a swing arm that can affect control by means of a steel wire and a recovery spring, the steel wire simultaneously linkage controls the aforementioned mutually exclusive mechanism;
according to the aforementioned, upon an operator pulling the steel wire tight, which thus pulls the swing arm, anticlockwise rotation of the operating rod is thereby actuated, whereafter, the pressure plate of the extremity of the operating rod presses on an extremity of the control shaft, moreover, the swing arm simultaneously presses on the mutually exclusive mechanism, which thereby enables the friction block to realize clamping of the housing of the differential gear set, and thereby achieves effectiveness of producing acceleration; when load is relatively large, because of increase in counteractive torque on a casing of the electric motor, thus slackening of the steel wire results, which thereby enables the brake to clamp the clutch plate and effectuate braking, and achieves effectiveness of producing automatic deceleration, when load recovery is relatively small, then counterforce of the casing of the electric motor is reduced, and automatic tightening of the steel wire is effectuated, which results in effectiveness of automatic acceleration, in addition, during period the steel wire maintains a slackened state, the brake continues to clamp and hold the clutch plate, thereby enabling the control shaft to push the pressure plate, and thus effectuate a reverse rotation of the swing arm, which thereby realizes automatic tightening on the steel wire, resulting in stopping rotation, and thus achieves preventing a phenomenon of mechanistic deadlock from occurring.
